(19) United States
(12) Patent Application Publication
(10) Pub. No.: US 2020/0224476 A1
(43) Pub. Date: Jul. 16, 2020

(54) VEHICLE DOOR DEVICE

(71) Applicant: AISIN SEIKI KABUSHIKI KAISHA, Kariya-shi (JP)

(72) Inventor: Kosuke KITO, Kariya-shi (JP)

(73) Assignee: AISIN SEIKI KABUSHIKI KAISHA, Kariya-shi (JP)

(21) Appl. No.: 16/735,749

(22) Filed: Jan. 7, 2020

(30) Foreign Application Priority Data
Jan. 10, 2019 (JP) 2019-002363

(51) Int. Cl. E05F 5/00; B60J 5/04

(52) U.S. Cl. CPC E05F 5/00; B60J 5/04; E05Y 2400/202; E05Y 2201/21; E05Y 2201/232; E05Y 2900/531

(57) ABSTRACT

A vehicle door device includes: a braking control unit applying a braking force to a swing door of a vehicle by controlling an operation of a braking device; an action position detection unit detecting an action position of the swing door; and a vertical displacement detection unit detecting a vertical displacement of the swing door. The braking control unit does not execute braking control in a case where the action position of the swing door changes with the vertical displacement exceeding a predetermined gripping operation determination value, even in a case where an execution condition of braking control for applying the braking force is satisfied.

### CROSS REFERENCE TO RELATED APPLICATIONS

This application is based on and claims priority under 35 U.S.C. § 119 to Japanese Patent Application 2019-002363, filed on Jan. 10, 2019, the entire contents of which are incorporated herein by reference.

### TECHNICAL FIELD

This disclosure relates to a vehicle door device.

### BACKGROUND DISCUSSION

Known in the related art is a door device that controls the opening/closing action of a vehicular swing door by applying a braking force to the swing door. For example, the door device described in Reference 1 is capable of applying a braking force to the swing door by using an assistance mechanism that uses a motor as a drive source for a braking device. In addition, this door device has a function of detecting input of disturbance to the swing door such as the inclination of a road surface and a strong wind. Further, in a case where such disturbance input is detected, the opening/closing load is increased, that is, the action is made heavy by a braking force being applied to the swing door. As a result, the swing door is configured not to perform a strong action attributable to the disturbance input.

However, in the configuration of the related art described above, the braking force application to the swing door may interfere with an opening/closing operation performed by an occupant. The operability of the swing door may be reduced as a result and there is still room for improvement in this regard.

Thus, a need exists for a vehicle door device which is not susceptible to the drawback mentioned above.

### SUMMARY

A vehicle door device according to an aspect of this disclosure includes a braking control unit applying a braking force to a swing door of a vehicle by controlling an operation of a braking device, an action position detection unit detecting an action position of the swing door, and a vertical displacement detection unit detecting a vertical displacement of the swing door. The braking control unit does not execute braking control in a case where the action position of the swing door changes with the vertical displacement exceeding a predetermined gripping operation determination value, even in a case where an execution condition of braking control for applying the braking force is satisfied.

### BRIEF DESCRIPTION OF THE DRAWINGS

The foregoing and additional features and characteristics of this disclosure will become more apparent from the following detailed description considered with the reference to the accompanying drawings, wherein:

FIG. 1 is a plan view of a vehicle provided with a swing door;

FIG. 2 is a perspective view of the swing door;

FIG. 3 is a schematic configuration diagram of a vehicle door device;

FIG. 4 is a flowchart illustrating a processing procedure with regard to a braking control execution determination;

FIG. 5 is a flowchart illustrating a processing procedure with regard to a braking control necessity determination;

FIG. 6 is a flowchart illustrating a processing procedure with regard to a door holding control execution determination;

FIG. 7 is an explanatory diagram illustrating a mode of door holding control; and

FIG. 8 is a schematic configuration diagram of a vehicle door device of another example.

### DETAILED DESCRIPTION

Hereinafter, an embodiment in which a vehicle door device is embodied will be described with reference to the drawings.

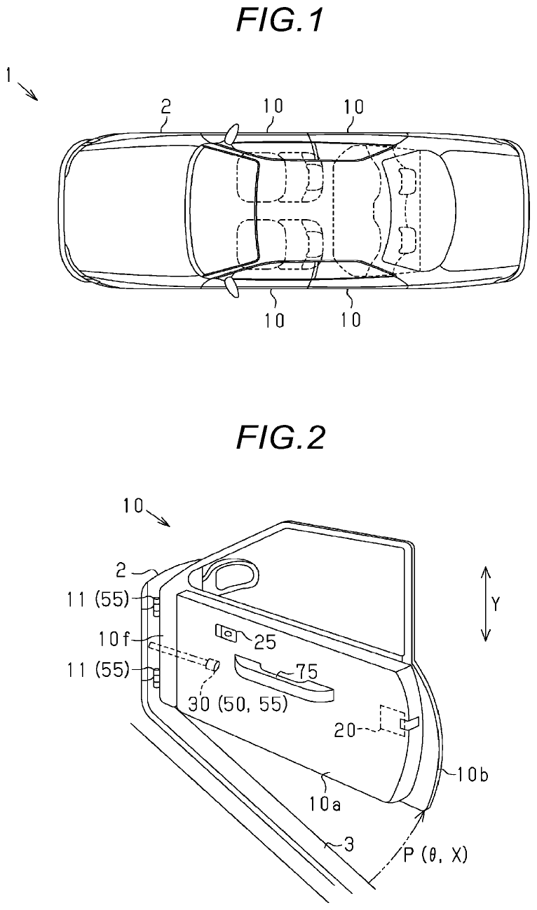

As illustrated in FIGS. 1 and 2, a vehicle 1 according to the present embodiment is provided with four swing doors 10 opening/closing door openings 3 provided in the side surfaces of a vehicle body 2. In other words, each of these swing doors 10 rotates around a hinge 11 as a fulcrum provided in a front end portion 10f of the swing door 10. The vehicle 1 according to the present embodiment is configured such that each of these swing doors 10 is opened/closed beside each seat provided in the interior of the vehicle 1.

Specifically, as illustrated in FIG. 2, the swing door 10 of the present embodiment is provided with a latch mechanism 20 that restrains the swing door 10 at a fully closed position by engaging with a striker (not illustrated) provided on the vehicle body 2 side. Further, the restraint on the swing door 10 of the present embodiment by the latch mechanism 20 is released by a door handle 25 being operated. As a result, the swing door 10 of the vehicle 1 of the present embodiment can be manually opened/closed.

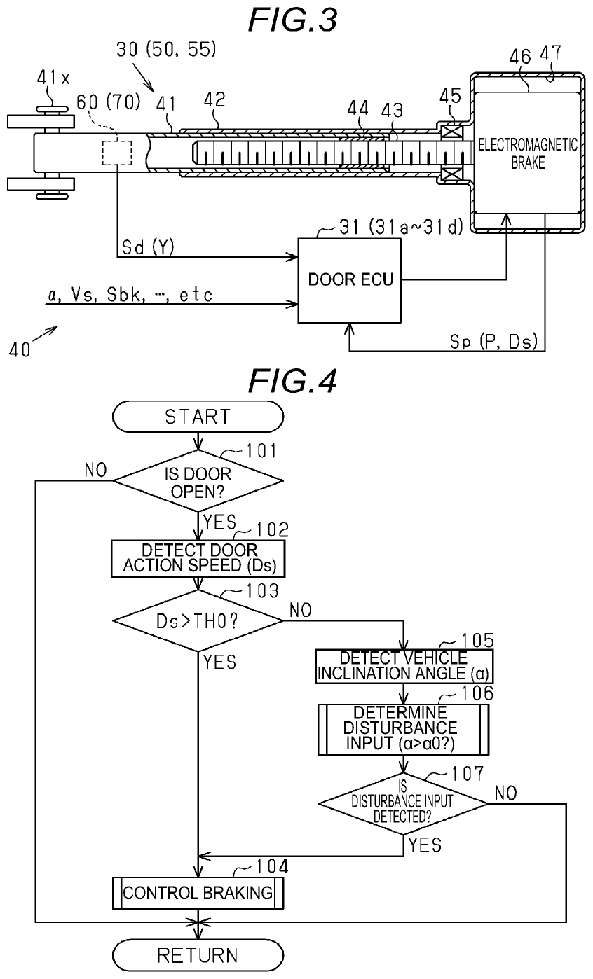

In addition, as illustrated in FIGS. 2 and 3, the swing door 10 of the present embodiment is provided with a door check device 30 having a braking function for applying a braking force to the swing door 10. Further, in the vehicle 1 of the present embodiment, the operation of the door check device 30 is controlled by a door ECU 31. As a result, a door device 40 that is capable of braking the swing door 10 and holding an action position P is formed in the vehicle 1 of the present embodiment.

More specifically, the door check device 30 of the present embodiment is provided with an inner tube 41 and an outer tube 42, one end of the inner tube 41 is rotatably connected to the vehicle body 2, and one end of the outer tube 42 is rotatably connected to the swing door 10 in a state where the inner tube 41 is inserted in the outer tube 42. In addition, the door check device 30 is provided with a spindle screw 43 that is coaxially disposed in the tubes of the inner tube 41 and the outer tube 42 extending in a substantially horizontal direction. Further, the spindle screw 43 is rotatably and pivotally supported by a bearing 45 fixed in the tube of the outer tube 42 in a state of being screwed in a spindle nut 44 fixed in the tube of the inner tube 41. The door check device 30 according to the present embodiment is provided with an electromagnetic brake 46 connected to one end of the spindle screw 43.

In other words, the door check device 30 of the present embodiment is configured such that the inner tube 41 and the outer tube 42 are axially and relatively displaced as the swing door 10 is opened/closed. Further, the door check device 30 is configured such that the spindle screw 43 rotates as a result of the relative displacement of the inner tube 41 and the outer tube 42. The door check device 30 of the present embodiment is configured such that the braking force is applied to the swing door 10 by the rotation of the spindle screw 43 being braked by the electromagnetic brake 46.

In the door check device 30 of the present embodiment, the electromagnetic brake 46 is held in a housing chamber 47 provided at one end of the outer tube 42. In addition, the door check device 30 of the present embodiment has a configuration in which one end side of the outer tube 42 is rotatably connected to the swing door 10 integrally with the electromagnetic brake 46 and via a bracket (not illustrated). The door ECU 31 of the present embodiment is configured to control the braking force applied to the swing door 10 through drive electric power supply to the electromagnetic brake 46.

More specifically, the door check device 30 of the present embodiment outputs a pulse signal Sp synchronized with the rotation of the spindle screw 43. The door ECU 31 of the present embodiment is configured to detect the action position P and an action speed Ds of the swing door 10 by counting the pulse signal Sp.

The action position P of the swing door 10 can be expressed as, for example, an opening action angle θ of the swing door 10 or an action distance X based on the fully closed or fully open position of a rear end portion 10b positioned at the distal end of the swing door 10 that is opened/closed (see FIG. 2).

Further, a vehicle state quantity such as a vehicle speed Vs and an inclination angle α of the vehicle 1 and a control signal such as a brake signal Sbk are input to the door ECU 31 of the present embodiment. The inclination angle α can be detected by an acceleration sensor provided in the vehicle 1 or the like. In addition, the door ECU 31 of the present embodiment detects inclination in the vehicle width direction, that is, a roll angle component as the inclination angle α of the vehicle. The door ECU 31 of the present embodiment is configured to execute braking control for the swing door 10 by means of the door check device 30 as a braking device 50 based on the vehicle information.

Specifically, as illustrated in the flowchart of FIG. 4, in a case where the swing door 10 is in an open state (Step 101: YES), the door ECU 31 of the present embodiment first detects the action speed Ds of the swing door 10 (Step 102) and compares the action speed Ds with a predetermined threshold value TH0 (Step 103). In a case where the door ECU 31 of the present embodiment determines that the action speed Ds exceeds the threshold value TH0(Ds>TH0, Step 103: YES), the door ECU 31 of the present embodiment executes the braking control for the swing door 10 (Step 104).

In addition, in a case where the door ECU 31 of the present embodiment determines in Step 103 that the action speed Ds of the swing door 10 is equal to or less than the predetermined threshold value TH0 (Ds≤TH0, Step 103: NO), the door ECU 31 of the present embodiment subsequently detects the inclination angle α of the vehicle 1 (Step 105). Further, the door ECU 31 determines whether or not the inclination angle α results in an external force to change the action position P of the swing door 10, that is, whether or not the inclination angle α corresponds to disturbance input (Step 106). In a case where the door ECU 31 of the present embodiment detects the inclination angle α that exceeds a predetermined threshold value α0 (α>α0), the door ECU 31 determines that the inclination angle α corresponds to the disturbance input. The door ECU 31 of the present embodiment is configured to execute the braking control for the swing door 10 in Step 104 even in a case where the disturbance input is detected as a result (Step 107: YES).

In other words, the swing door 10 may perform a strong action in a strong wind, by an occupant operating the swing door 10 so as to push the swing door 10, or the like. A problematically loud sound is likely to be generated by the swing door 10 reaching the fully open position or the fully closed position in this state or contact or pinching with respect to a surrounding object such as an adjacent vehicle is likely to occur as a problem.

In this regard, the door ECU 31 of the present embodiment executes the braking control for the swing door 10 on execution condition that the action speed Ds of the swing door 10 exceeds the predetermined threshold value TH0 as described above. In addition, in a case where the vehicle 1 is inclined, the swing door 10 may be accelerated by gravity. Accordingly, the door ECU 31 of the present embodiment further executes the braking control for the swing door 10 on execution condition that the inclination angle α of the vehicle 1 corresponds to the disturbance input resulting in an external force to change the action position P of the swing door 10. The door device 40 of the present embodiment is configured to ensure a high texture and safety as a result.

The door ECU 31 of the present embodiment switches the content of the braking control executed in Step 104 when the execution condition based on the action speed Ds of the swing door 10 is satisfied (Step 103: YES) and when the execution condition based on the detection of the inclination angle α is satisfied (Step 107: YES). As a result, the door device 40 of the present embodiment is capable of applying an optimum braking force to the swing door 10 in accordance with the situation of the swing door 10.

### (Function of Determining Necessity of Braking Control)

Next, the braking control necessity determination function that is implemented in the door device 40 of the present embodiment will be described.

As illustrated in FIG. 3, the door device 40 of the present embodiment is provided with a component of the door check device 30 having a function as a connecting member 55 intervening between the swing door 10 and the vehicle body 2 as described above. Specifically, the door device 40 is provided with a distortion sensor 60 fixed to the inner tube 41 extending in a substantially horizontal direction by one end being rotatably connected to the vehicle body 2. Further, the door ECU 31 of the present embodiment detects a vertical displacement Y of the swing door 10 based on an output signal Sd by using the distortion sensor 60 as a displacement sensor 70. The door ECU 31 of the present embodiment is configured to execute the braking control necessity determination as described above based on the detected vertical displacement Y of the swing door 10.

In other words, as illustrated in FIG. 2, in a case where an occupant of the vehicle 1 operates the swing door 10 by gripping, for example, a grip portion 75 provided on a door trim 10a, it is rare that the direction of the operation force completely coincides with the original action trajectory of the swing door 10, that is, an action trajectory in a non-gripping state. The vertical displacement Y is generated in the swing door 10 based on the vertical component of this “misaligned operation force”.

In addition, at this time, the connecting member 55 intervening between the swing door 10 and the vehicle body 2 is likely to be distorted based on the vertical displacement Y generated in the swing door 10. This distortion tends to be more prominent in a horizontally extending component.

In the door device 40 of the present embodiment, the distortion sensor 60 is disposed in the inner tube 41 of the door check device 30 by using this. The door ECU 31 of the present embodiment is configured to detect the vertical displacement Y of the swing door 10 based on the distortion amount that is indicated by the output signal Sd of the distortion sensor 60.

Further, in a case where an occupant of the vehicle 1 opens/closes the swing door 10 with the swing door 10 gripped, it is conceivable that the external force can be appropriately countered by the operation force of the occupant even in the event of the disturbance input such as the inclination of the vehicle 1 and a strong wind. In a state where the swing door 10 is gripped by the occupant in this manner, it can be estimated that a rise in the action speed Ds is also attributable to an operation intended by the occupant.

In this regard, the door ECU 31 of the present embodiment compares a predetermined gripping operation determination value Y1 with the vertical displacement Y of the swing door 10 detected by means of the distortion sensor 60 as the displacement sensor 70 in a case where the action position P of the swing door 10 continuously changes, that is, in a case where the swing door 10 is in action. The gripping operation determination value Y1, which is based on the value of the vertical displacement Y as a reference in the case of action of the swing door 10 in a state where the swing door 10 is gripped by no occupant, is set in advance to a value larger than the reference value at the time of non-gripping state action. The door ECU 31 of the present embodiment does not execute the braking control for the swing door 10, even in a case where the execution condition illustrated in FIG. 4 is satisfied, in a case where the vertical displacement Y is larger than the predetermined gripping operation determination value Y1 (Y>Y1), that is, in a case where it is estimated that the swing door 10 is operated with the swing door 10 gripped by an occupant.

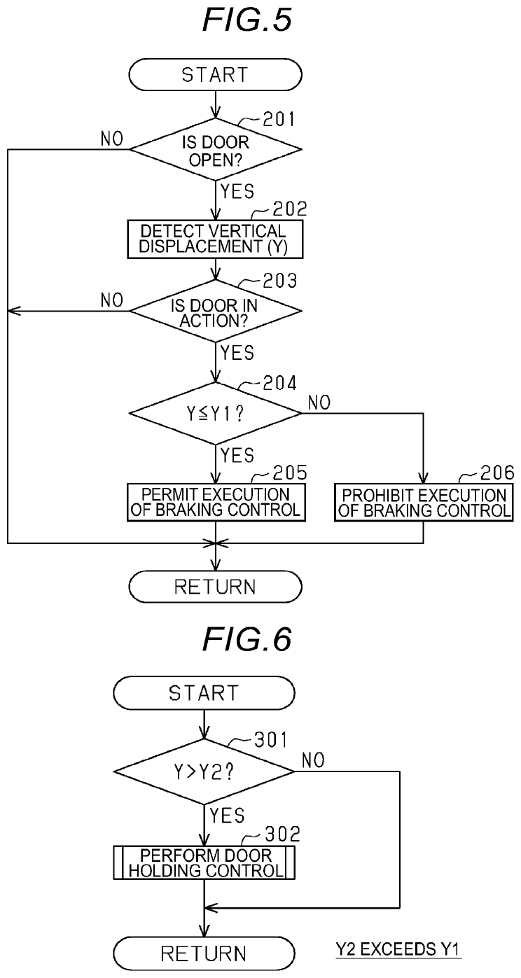

Specifically and as illustrated in the flowchart of FIG. 5, the door ECU 31 of the present embodiment detects the vertical displacement Y of the swing door 10 (Step 202) in a case where the swing door 10 is in the open state (Step 201: YES). In addition, the door ECU 31 determines whether or not the swing door 10 is in action (Step 203) and the door ECU 31 compares the vertical displacement Y of the swing door 10 detected in Step 202 with the predetermined gripping operation determination value Y1 (Step 204) in a case where the swing door 10 is in action (Step 203: YES). In a case where the vertical displacement Y of the swing door 10 is equal to or less than the gripping operation determination value Y1 (Y Y1, Step 204: YES), the execution of the braking control with respect to the swing door 10 is permitted (Step 205).

Further, the door ECU 31 of the present embodiment prohibits the execution of the braking control (Step 206) in a case where the vertical displacement Y is larger than the gripping operation determination value Y1 in Step 204, that is, in a case where the action position P of the swing door 10 changes with the vertical displacement Y that exceeds the gripping operation determination value Y1 (Y>Y1, Step 205: NO). As a result, the door device 40 of the present embodiment is configured such that the braking force application resulting from the execution of the braking control does not interfere with the opening/closing operation of the swing door 10 performed by an occupant.

In addition, as illustrated in the flowchart of FIG. 6, the door ECU 31 of the present embodiment compares the detected vertical displacement Y of the swing door 10 with a door holding determination threshold value Y2 set to a value larger than the gripping operation determination value Y1 (Step 301). Further, in a case where the door ECU 31 of the present embodiment determines in Step 301 that the vertical displacement Y that exceeds the door holding determination threshold value Y2 is detected (Y>Y2, Step 301: YES), the door ECU 31 of the present embodiment applies a braking force to the swing door 10 by controlling the operation of the door check device 30 with an exception of the prohibition of the execution of the braking control. In this configuration, door holding control for holding the action position P of the swing door 10 is executed based on the application of the braking force.

Specifically, the door device 40 of the present embodiment is configured such that the vertical displacement Y that exceeds the door holding determination threshold value Y2 is detected by an occupant operating the swing door 10 intentionally applying an operation force in the vertical direction to the swing door 10, examples of which include downward pushing of the swing door 10. The door holding control is executed as a result, and then an operation force for holding the swing door 10 in the open state becomes unnecessary and the swing door 10 in which the action position P is held can be used for an entry/exit support.

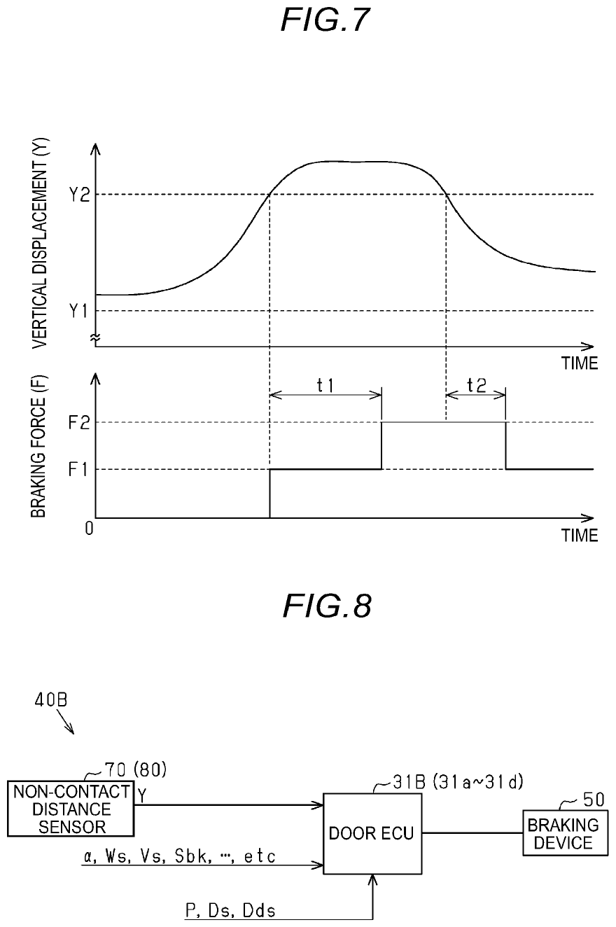

More specifically, as illustrated in FIG. 7, in a case where the door ECU 31 of the present embodiment detects the vertical displacement Y that exceeds the door holding determination threshold value Y2, the door ECU 31 of the present embodiment first controls, as the door holding control, the operation of the door check device 30 such that a braking force F applied to the swing door 10 becomes a first braking force F1. Further, the door ECU 31 maintains the first braking force F1 for a predetermined time t1, and then changes the braking force F applied to the swing door 10 from the first braking force F1 to a second braking force F2 larger than the first braking force F1 (F1<F2). The door ECU 31 of the present embodiment increases the braking force F applied to the swing door 10 over time in this manner. As a result, even in a case where the application of the braking force is initiated during the action of the swing door 10, the swing door 10 is smoothly braked without discomfort and the action position P is held.

In addition, after the detected value of the vertical displacement Y becomes equal to or less than the door holding determination threshold value Y2, the door ECU 31 of the present embodiment maintains the braking force F applied to the swing door 10 at the second braking force F2 for a predetermined time t2. After the elapse of the predetermined time t2, the action position P is continuously held in a state where the braking force F applied to the swing door 10 is reduced from the second braking force F2 to the first braking force F1.

Next, the effects of the present embodiment will be described.

(1) The door ECU 31 has a function as a braking control unit 31a applying a braking force to the swing door 10 of the vehicle 1 by controlling the operation of the door check device 30 serving as the braking device 50. In addition, the door ECU 31 has a function as an action position detection unit 31b detecting the action position P of the swing door 10. Further, the door ECU 31 has a function as a vertical displacement detection unit 31c detecting the vertical displacement of the swing door 10. The door ECU 31 does not execute the braking control, even in the case of satisfaction of the execution condition of the braking control for applying a braking force to the swing door 10, in a case where the action position P of the swing door 10 changes with the vertical displacement Y that exceeds the predetermined gripping operation determination value Y1.

In other words, in a case where an occupant of the vehicle 1 operates the swing door 10 with the swing door 10 gripped, the direction of the operation force often deviates either upward or downward. Accordingly, in a case where it is determined that the swing door 10 is in action with the vertical displacement Y that is larger than in the case of action in the non-gripping state, it can be estimated that the action of the swing door 10 is attributable to an operation in a gripping state performed by the occupant. Accordingly, with the configuration described above, it is possible to improve operability by avoiding interference between the application of the braking force resulting from the execution of the braking control by means of the braking device 50 and the opening/closing operation of the swing door 10 performed by an occupant.

(2) The door device 40 is provided with the component of the door check device 30 as the connecting member 55 intervening between the swing door 10 and the vehicle body 2. Specifically, the door device 40 is provided with the distortion sensor 60 fixed to the inner tube 41 extending in a substantially horizontal direction by one end being rotatably connected to the vehicle body 2. The door device 40 detects the vertical displacement Y of the swing door 10 based on the output signal Sd of the distortion sensor 60.

In other words, the connecting member 55 intervening between the swing door 10 and the vehicle body 2 is likely to be distorted based on the vertical displacement Y generated in the swing door 10. Further, this distortion tends to be more prominent in a horizontally extending component. Accordingly, with the configuration described above, it is possible to detect the vertical displacement Y of the swing door 10 by means of a simple configuration.

(3) The door ECU 31 executes the braking control for the swing door 10 on execution condition that the action speed Ds of the swing door 10 exceeds the predetermined threshold value TH0.

In other words, the swing door 10 may perform a strong action in a strong wind, by an occupant operating the swing door 10 so as to push the swing door 10, or the like. A problematically loud sound is likely to be generated by the swing door 10 reaching the fully open position or the fully closed position in this state or contact or pinching with respect to a surrounding object is likely to occur as a problem.

However, with the configuration described above, it is possible to forestall such problems and ensure a high texture and safety. In a case where the swing door 10 is operated with the swing door 10 gripped by an occupant, it is possible to allow the occupant to quickly open/close the swing door 10 by not performing the braking force application by means of the braking device 50.

(4) The door ECU 31 as a disturbance detection unit 31d detects the inclination angle α of the vehicle 1. Further, the door ECU 31 determines whether or not the inclination angle α results in an external force to change the action position P of the swing door 10, that is, whether or not the inclination angle α corresponds to disturbance input. As a result, the braking control for the swing door 10 is executed on condition that the disturbance input is detected.

In other words, in a case where the vehicle 1 is inclined, the swing door 10 may be accelerated by gravity. Then, the swing door 10 may perform a strong action. However, with the configuration described above, it is possible to suppress the action of the swing door 10 resulting from disturbance input attributable to the inclination of the vehicle 1. In a case where the swing door 10 is operated with the swing door 10 gripped by an occupant, a smooth opening/closing operation by the occupant can be ensured without braking force application by the braking device 50.

(5) The door ECU 31 holds the action position P of the swing door 10 by applying a braking force to the swing door 10 in a case where the vertical displacement Y that exceeds the door holding determination threshold value Y2 set to a value larger than the gripping operation determination value Y1 is detected (Y>Y2).

With the configuration described above, an occupant operating the swing door 10 can hold the action position P of the swing door 10 by intentionally applying an operation force to result in the generation of the vertical displacement Y, examples of which include downward pushing of the swing door 10. As a result, an operation force for holding the swing door 10 in the open state becomes unnecessary and the swing door 10 in which the action position P is held can be used for an entry/exit support.

Further, a series of actions from an operation for pushing down the swing door 10 in order to hold the action position P of the swing door 10 to entry/exit by means of the swing door 10 in which the action position P is held can be naturally performed without discomfort. As a result, it is possible to ensure operability excellently.

(6) In a case where a braking force is applied to the swing door 10 so that the action position P of the swing door 10 is held, the door ECU 31 first uses the first braking force F1 as the braking force F that is applied to the swing door 10. The first braking force F1 is maintained for the predetermined time t1, and then the braking force F is changed to the second braking force F2 larger than the first braking force F1 (F1<F2).

The braking force applied to the swing door 10 is increased over time as described above. As a result, even in a case where the application of the braking force is initiated during the action of the swing door 10, the swing door 10 can be smoothly braked without discomfort and the action position P can be held. As a result, it is possible to ensure operability excellently and texture improvement can be achieved at the same time.

The embodiment described above can be implemented with the following modifications. The embodiment described above and the following modification examples can be implemented in combination with each other within a technically consistent scope.

Although a braking force is applied to the swing door 10 by means of the door check device 30 having a braking function in the above embodiment, the configuration of the braking device 50 may be changed in any manner, examples of which include using the braking device 50 that is provided separately from the door check device 30.

In the embodiment described above, the distortion sensor 60 is disposed in the inner tube 41 of the door check device 30 (see FIG. 3). The vertical displacement Y of the swing door 10 is detected by the distortion sensor 60 being used as the displacement sensor 70. However, the embodiment disclosed here is not limited thereto. For example, the component of the door check device 30 where the distortion sensor 60 is disposed may be changed to any component, examples of which include the outer tube 42 and a connecting shaft 41x of the inner tube 41 with respect to the vehicle body 2. In another configuration, the distortion sensor 60 serving as the displacement sensor 70 may be disposed with respect to the connecting member 55 other than the door check device 30, examples of which include the hinge 11 connecting the swing door 10 to the vehicle body 2.

In addition, as in a door device 40B illustrated in FIG. 8, a door ECU 31 B as the vertical displacement detection unit 31c may detect the vertical displacement Y of the swing door 10 by using a non-contact distance sensor 80 as the displacement sensor 70. A capacitance sensor or the like can be used as the distance sensor 80 capable of detecting the vertical displacement Y of the swing door 10 in a non-contact manner. Further, the distance sensor 80 that is an optical or sonic sensor may be used for the displacement sensor 70. In addition, the distance sensor 80 and the distortion sensor 60 may be used in combination as the displacement sensor 70.

The displacement sensor 70 may detect only one of the direction in which the swing door 10 is pushed downward and the direction in which the swing door 10 is lifted upward as the vertical displacement Y of the swing door 10.

Further, assuming that the swing door 10 is in the open state, the action range of the swing door 10 in which the braking control is executed and the action range of the swing door 10 in which the vertical displacement Y is detected by means of the displacement sensor 70 may be changed to any ranges. For example, an unlatch position where the restraint of the swing door 10 by the latch mechanism 20 is released may be used as a starting point and a half latch position where the restraint is loosened may be used as a starting point.

Although the braking control for the swing door 10 is executed on execution condition that the action speed Ds of the swing door 10 exceeds the predetermined threshold value THO in the embodiment described above, application may be performed to a configuration in which the braking control is executed in a case where the swing door 10 has an acceleration Dds exceeding a predetermined threshold value.

In addition, application may be performed to a configuration in which disturbance input is detected by means of a state quantity other than the inclination angle α of the vehicle 1. For example, it may be determined whether the wind that is blown to the swing door 10 generates an external force to change the action position P of the swing door 10, that is, corresponds to disturbance input by a wind speed Ws around the vehicle 1 being detected and braking control to suppress the disturbance may be subsequently executed.

Although the condition determination relating to the action speed Ds of the swing door 10 is made independently of the disturbance input determination in the embodiment described above, such an action speed determination may be used for the disturbance input determination. In addition, the disturbance input may be detected by a plurality of state quantities being combined in any manner, examples of the state quantities including the action speed Ds or the acceleration Dds of the swing door 10 and the inclination angle α of the vehicle 1 or the wind speed Ws.

Further, application may be performed to a configuration in which the braking control for the swing door 10 is executed only during either an opening direction action or a closing direction action. In addition, each individual content of the braking control may be set in any manner in accordance with the execution condition. For example, the braking force that is applied to the swing door 10 may be changed over time as in the door holding control according to the embodiment described above. In addition, the direction in which the braking force gradually changes may be changed in any manner.

In the embodiment described above, the first braking force F1 is used first as the braking force F applied to the swing door 10 in a case where a braking force is applied to the swing door 10 so that the action position P of the swing door 10 is held. The first braking force F1 is maintained for the predetermined time t1, and then the braking force F is changed to the second braking force F2 larger than the first braking force F1 (F1<F2). However, the embodiment disclosed here is not limited thereto. For example, a configuration may be used in which the braking force is increased through three or more switching steps. In another configuration, the braking force may be continuously and gradually increased. In addition, this is not excluded with regard to a configuration in which the braking force that is applied first is used as the maximum value in the braking control without the braking force being increased over time as described above.

In the embodiment described above, the braking force F applied to the swing door 10 is maintained at the second braking force F2 for the predetermined time t2 after the detected value of the vertical displacement Y becomes equal to or less than the door holding determination threshold value Y2. After the elapse of the predetermined time t2, the action position P is continuously held in a state where the braking force F applied to the swing door 10 is reduced from the second braking force F2 to the first braking force F1. However, the embodiment disclosed here is not limited thereto and the braking force applied to the swing door 10 may be reduced at any timing. In another configuration, the braking force may be reduced through three or more switching steps or the braking force may be continuously and gradually reduced. Further, the braking force may be kept constant until the braking force application to the swing door 10 is stopped without the braking force being reduced over time as described above. Likewise, the braking force application may be stopped at any timing.

Next, the technical idea that can be grasped from the embodiment and the modification examples will be described.

A vehicle door device according to an aspect of this disclosure includes a braking control unit applying a braking force to a swing door of a vehicle by controlling an operation of a braking device, an action position detection unit detecting an action position of the swing door, and a vertical displacement detection unit detecting a vertical displacement of the swing door. The braking control unit does not execute braking control in a case where the action position of the swing door changes with the vertical displacement exceeding a predetermined gripping operation determination value, even in a case where an execution condition of braking control for applying the braking force is satisfied.

That is, in a case where an occupant of the vehicle operates the swing door with the swing door gripped, the direction of the operation force often deviates either upward or downward. Accordingly, in a case where it is determined that the swing door is in action with the vertical displacement that is larger than in the case of action in a non-gripping state, it can be estimated that the action of the swing door is attributable to an operation in a gripping state performed by the occupant. Accordingly, with the configuration described above, it is possible to improve operability by avoiding interference between the application of the braking force resulting from the execution of the braking control by means of the braking device and the opening/closing operation of the swing door performed by an occupant.

In the vehicle door device according to the aspect of this disclosure, it is preferable that the vertical displacement detection unit is formed by a distortion sensor being disposed in a connecting member intervening between the swing door and a vehicle body.

That is, the connecting member intervening between the swing door and the vehicle body is likely to be distorted based on the vertical displacement generated in the swing door. Accordingly, with the configuration described above, it is possible to detect the vertical displacement of the swing door by means of a simple configuration.

In the vehicle door device according to the aspect of this disclosure, it is preferable that the vertical displacement detection unit is provided with a distance sensor capable of detecting the vertical displacement in a non-contact manner.

With the configuration described above, it is possible to more directly detect the vertical displacement of the swing door. In addition, it is possible to improve mountability with respect to the vehicle by using the advantage that the distance sensor is a non-contact sensor.

In the vehicle door device according to the aspect of this disclosure, it is preferable that the braking control unit executes the braking control on the execution condition that an action speed of the swing door exceeds a predetermined threshold value.

The swing door may move rapidly in a strong wind, by an occupant operating the swing door so as to push the swing door, or the like. A problematically loud sound is likely to be generated by the swing door reaching a fully open position or a fully closed position in this state or contact to or pinching of a surrounding object is likely to occur as a problem.

However, with the configuration described above, it is possible to forestall such problems and ensure a high texture and safety. In a case where the swing door is operated with the swing door gripped by an occupant, it is possible to allow the occupant to quickly open/close the swing door by not performing the braking force application by means of the braking device.

It is preferable that the vehicle door device according to the aspect of this disclosure further includes a disturbance detection unit detecting input of disturbance changing the action position of the swing door and the braking control unit executes the braking control on the execution condition of the input of the disturbance.

With the configuration described above, it is possible to suppress the action of the swing door resulting from disturbance input and ensure a high texture and safety. In a case where the swing door is operated with the swing door gripped by an occupant, a smooth opening/closing operation by the occupant can be ensured without braking force application by the braking device.

In the vehicle door device according to the aspect of this disclosure, it is preferable that the braking control unit holds the action position of the swing door by applying a braking force to the swing door in a case where the vertical displacement exceeding a door holding determination threshold value set to a value larger than the gripping operation determination value is detected.

With the configuration described above, an occupant operating the swing door can hold the action position of the swing door in an easy and simple manner by intentionally applying an operation force to result in the generation of the vertical displacement, examples of which include downward pushing of the swing door. As a result, an operation force for holding the swing door in an open state becomes unnecessary and the swing door in which the action position is held can be used for an entry/exit support.

Further, a series of actions from an operation for pushing down the swing door in order to hold the action position of the swing door to entry/exit by means of the swing door in which the action position is held can be naturally performed without discomfort. As a result, it is possible to ensure operability excellently.

In the vehicle door device according to the aspect of this disclosure, it is preferable that the braking control unit increases the braking force over time in a case where the braking force is applied to the swing door so that the action position of the swing door is held.

With the configuration described above, the swing door can be smoothly braked without discomfort and the action position can be held even in a case where the application of the braking force is initiated during the action of the swing door. As a result, it is possible to ensure operability excellently and texture improvement can be achieved at the same time.

A vehicle door device according to an aspect of this disclosure includes a vertical displacement detection unit detecting a vertical displacement of a swing door provided in a vehicle and a braking control unit applying a braking force to the swing door in a case where the vertical displacement exceeding a predetermined holding determination threshold value is detected.

According to the aspect of this disclosure, it is possible to improve operability.

The principles, preferred embodiment and mode of operation of the present invention have been described in the foregoing specification. However, the invention which is intended to be protected is not to be construed as limited to the particular embodiments disclosed. Further, the embodiments described herein are to be regarded as illustrative rather than restrictive. Variations and changes may be made by others, and equivalents employed, without departing from the spirit of the present invention. Accordingly, it is expressly intended that all such variations, changes and equivalents which fall within the spirit and scope of the present invention as defined in the claims, be embraced thereby.

What is claimed is:

1. A vehicle door device comprising:
a braking control unit applying a braking force to a swing door of a vehicle by controlling an operation of a braking device;
an action position detection unit detecting an action position of the swing door; and
a vertical displacement detection unit detecting a vertical displacement of the swing door, wherein
the braking control unit does not execute braking control in a case where the action position of the swing door changes with the vertical displacement exceeding a predetermined gripping operation determination value, even in a case where an execution condition of braking control for applying the braking force is satisfied.

2. The vehicle door device according to claim 1, wherein
the vertical displacement detection unit is formed by a distortion sensor being disposed in a connecting member intervening between the swing door and a vehicle body.

3. The vehicle door device according to claim 1, wherein
the vertical displacement detection unit is provided with a distance sensor capable of detecting the vertical displacement in a non-contact manner.

4. The vehicle door device according to claim 1, wherein
the braking control unit executes the braking control on the execution condition that an action speed of the swing door exceeds a predetermined threshold value.

5. The vehicle door device according to claim 1, further comprising
a disturbance detection unit detecting input of disturbance changing the action position of the swing door, wherein
the braking control unit executes the braking control on the execution condition of the input of the disturbance.

6. The vehicle door device according to claim 1, wherein
the braking control unit holds the action position of the swing door by applying a braking force to the swing door in a case where the vertical displacement exceeding a door holding determination threshold value set to a value larger than the gripping operation determination value is detected.

7. The vehicle door device according to claim 6, wherein
the braking control unit increases the braking force over time in a case where the braking force is applied to the swing door so that the action position of the swing door is held.

8. A vehicle door device comprising
a vertical displacement detection unit detecting a vertical displacement of a swing door provided in a vehicle; and
a braking control unit applying a braking force to the swing door in a case where the vertical displacement exceeding a predetermined holding determination threshold value is detected.
